(19) United States
(12) Patent Application Publication
(10) Pub. No.: US 2002/0087766 A1
(43) Pub. Date: Jul. 4, 2002

(54) Method and apparatus to implement a locked-bus transaction

(76) Inventors: Akhilesh Kumar, Sunnyvale, CA (US); Manoj Khare, Saratoga, CA (US); Lily P. Looi, Portland, OR (US); Ling Cen, Austin, TX (US); Kenneth C. Creta, Gig Harbor, WA (US); Steve Kulick, Portland, OR (US); Kai Cheng, Portland, OR (US); Robert George, Austin, TX (US); Sin S. Tan, Portland, OR (US)

Correspondence Address: KENYON & KENYON, Suite 600, 333 W. San Carlos, Street, San Jose, CA, 95110-2711, US

(21) Appl. No.: 09/751,623

(22) Filed: Dec. 29, 2000

(51) Int. Cl. G06F 13/00

(52) U.S. Cl. 710/108

(57) ABSTRACT

In a multi-node system, a method and apparatus to implement a locked-bus transaction is described. In one embodiment, a bus agent initiates a locked-bus transaction and a node controller defers the transaction so that it will be initiated again at a later time. The node controller then sends the locked bus request to one or more other node controllers in the system, which prevent bus transaction at their respective busses. Once the requesting node controller receives confirmation that the other nodes are locked, it can allow the locked-bus transaction to proceed from the bus agent.

### BACKGROUND OF THE INVENTION

The present invention pertains to preventing transactions of other components in the system from affecting the system state during several bus consecutive accesses by a primary device. More particularly, the present invention pertains to a multi-processor system where a primary processor is capable of locking other components to complete a series of transactions.

In known processor systems, the processor is coupled to a bus (sometimes referred to as a host bus or system bus) that allows transactions between the processor and other components (e.g., system memory or RAM (random access memory)). To insure that a series of transactions from a processor can be executed without interruption, the Intel Pentium® processor and the Intel Itanium™ processor (manufactured by Intel Corporation, Santa Clara, Calif.) may issue a LOCK# output (as used herein, the “#” indicates a negative assertion of the signal by changing the signal on the signal line from a high voltage level indicating binary “0” to a low voltage level indicating binary “1”). The LOCK# output informs bus arbitration logic that the system bus is “owned” by the processor and that the bus access should not be given to any other device requesting such access to the bus until the processor finishes the transfers.

An example of processor action that may use LOCK# output is a read-modify-write operation. During this operation, the processor first reads, over the system bus, the value in an external memory. The processor then modifies this value internally and writes the modified value, over the system bus, to the external memory. Because the value is being changed, the LOCK# feature is essential to preventing some other device from reading or writing the same location in external memory in between the read and write operations over the system bus. Failure to do so could cause an error in the system. As known in the art, the LOCK# feature can be used to insure exclusive access to the bus and other resources for two or more consecutive transactions.

Though the LOCK# output is effective in single and multi-processor systems that share resources over a single system bus, it is ineffective in a multi-processor system that shares resources over multiple system busses.

In view of the above, there is a need for a system and method to insure that a processor or the like can lock system resources to facilitate multiple transactions in this type of architecture.

### BRIEF DESCRIPTION OF THE DRAWINGS

FIG. 1 is a block diagram of a multiprocessor system operated according to an embodiment of the present invention.

FIGS. 2a-c are flow diagrams of a method for implementing a bus lock according to an embodiment of the present invention.

FIG. 3 is a block diagram of a system that does not include a switching agent and multiple nodes as shown in FIG. 1.

### DETAILED DESCRIPTION

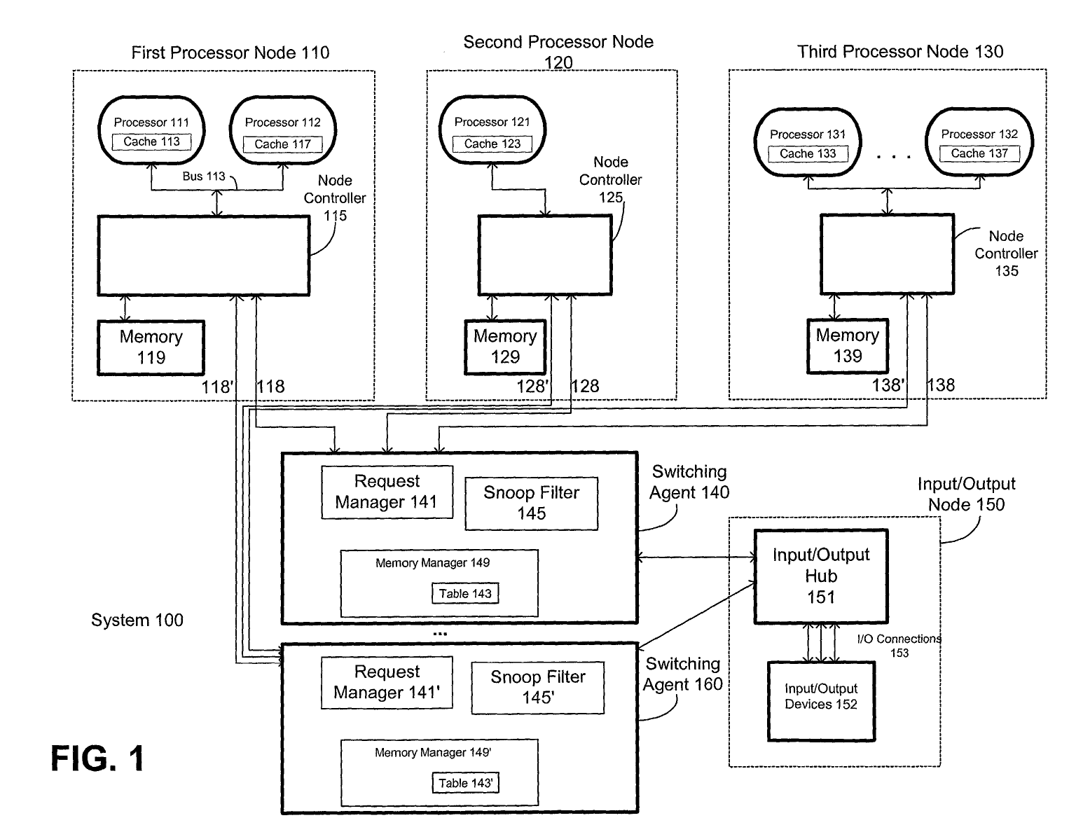

Referring to FIG. 1, a block diagram of a multiprocessor system operated according to an embodiment of the present invention is shown. In FIG. 1 a system having nodes that share memory devices is shown. A system 100 is a computer system that includes processors, memory devices, and input/output devices. Components in system 100 are arranged into architectural units that are referred to herein as nodes. Each node may contain one or more processors, memories, or input/output devices. In addition, the components within a node may be connected to other components in that node through one or more busses or lines. Each node in system 100 has a node connection that may be used by the components within that node to communicate with components in other nodes. In one embodiment, the node connection for a particular node is used for any communication from a component within that node to another node. In system 100, the node connection for each node is connected to a switching agent 140. A system that has multiple nodes is referred to as a multi-node system. A multi-node system for which each node communicates to other nodes through a dedicated connection may be said to have a point-to-point architecture.

The nodes in system 100 may cache data for the same memory block for one of the memories in the system. For example, a cache in each node in the system may contain a data element corresponding to a block of a system memory (e.g., a RAM memory that is located in one of the nodes). If a first node decides to modify its copy of this memory block, it may invalidate the copies of that block that are in other nodes (i.e., invalidate the cache lines) by sending an invalidate message to the other nodes. If the first node attempts to invalidate a cache line in the other nodes, and the second node has already modified that cache line, then the first node may read the new cache line from the second node before invalidating the cache line in the second node. In this way, the first node may obtain the updated data for that cache line from the first node before the first node operates on that data. After obtaining the updated data, the first node may invalidate the cache line in the second node. To accomplish this, the first node may send a read and invalidate request to the second node.

The details shown in FIG. 1 will now be discussed. As shown in FIG. 1, system 100 includes a first processor node 110, a second processor node 120, a third processor node 130, and an input/output node 150. Each of these nodes is coupled to switching agent 140 and switching agent 160. The term “coupled” encompasses a direct connection, an indirect connection, an indirect communication, etc. First processor node 110 is coupled to switching agent 140 through external connection 118 (and to switching agent 160 with external connection 118′), second processor node 120 is coupled to switching agent 140 through external connection 128 (and to switching agent 160 with external connection 128′), and third processor node 130 is coupled to switching agent 140 through external connection 138 (and to switching agent 160 with external connection 138′).

First processor node 110 includes processor 111, processor 112, and node controller 115, which are coupled to each other by bus 113. Processor 111 and processor 112 may be any micro-processors that are capable of processing instructions, such as for example a processor in the Intel Pentium® or Itanium™ family of processors. Bus 113 may be a shared bus. First node 110 also contains a memory 119, which is coupled to node controller 115. Memory 119 may be a Random Access Memory (RAM). Processor 111 may contain a cache 113, and processor 112 may contain a cache 117. Cache 113 and cache 117 may be Level 2 (L2) cache memories that are comprised of static random access memory.

Similarly, second processor node 120 contains a processor 121 and node controller 125 which are coupled to each other. Second processor node 120 also contains a memory 129 that is coupled to node controller 125. Third processor node 130 contains a processor 131, processor 132, and node controller 135 that are coupled to each other. Third processor node 130 also contains a memory 139 that is coupled to node controller 135. Processor 121 may contain a cache 123, processor 131 may contain a cache 133, and processor 132 may contain a cache 137. Processors 121, 131, and 132 may be similar to processors 111 and 112. In an embodiment, two or more of processors 111, 112, 121, 131, and 132 are capable of processing a program in parallel. Node controllers 125 and 135 may be similar to node controller 115, and memory 129 and 139 may be similar to memory 119. As shown in FIG. 1, third processor node 130 may contain processors in addition to 131 and 132. Similarly, first processor node 110 and second processor node 120 may also contain additional processors.

In one embodiment, switching agent 140 may be a routing switch for routing messages within system 100. As shown in FIG. 1, switching agent 140 may include a request manager 141, which may include a processor, for receiving requests from the processor nodes 110, 120, and 130. In this embodiment, request manager 141 includes a snoop filter 145, the operation of which is described below. A memory manager 149, which may include a table 143 or other such device, may be provided to store information concerning the status of the processor nodes as described below. Switching agent 160, likewise includes a request manager 141′, a memory manager 149′ and table 143′ along with snoop filter 145′. Though two switching agents 140, 160 are shown in FIG. 1, additional switching agents may be provided.

As shown in FIG. 1, input/output node 150 contains an input/output hub 151 that is coupled to one or more input/output devices 152 via I/O connections 153. Input/output devices 152 may be, for example, any combination of one or more of a disk, network, printer, keyboard, mouse, graphics display monitor, or any other input/output device. Input/output hub 151 may be an integrated circuit that contains bus interface logic for interfacing with a bus that complies to the Peripheral Component Interconnect standard (version 2.2, PCI Special Interest Group) or the like. Input/output devices 152 may be similar to, for example, the INTEL 82801AA I/O Controller Hub. Though one I/O Node is shown, two or more I/O Nodes may be coupled to the switching agents.

In an embodiment, node controller 115, switching agent 140, and input/output hub 151 may be a chipset that provides the core functionality of a motherboard, such as a modified version of a chipset in the INTEL 840 family of chipsets.

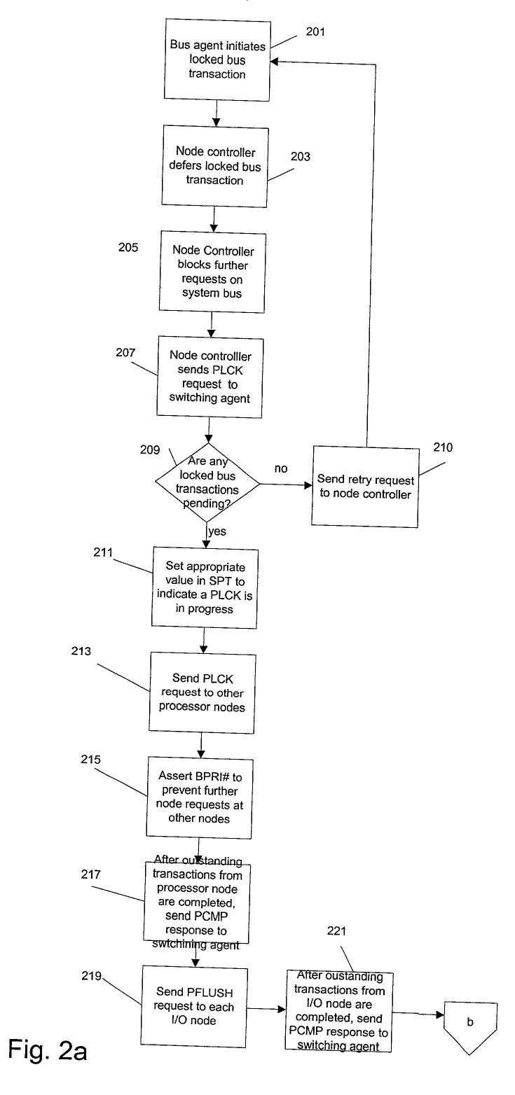

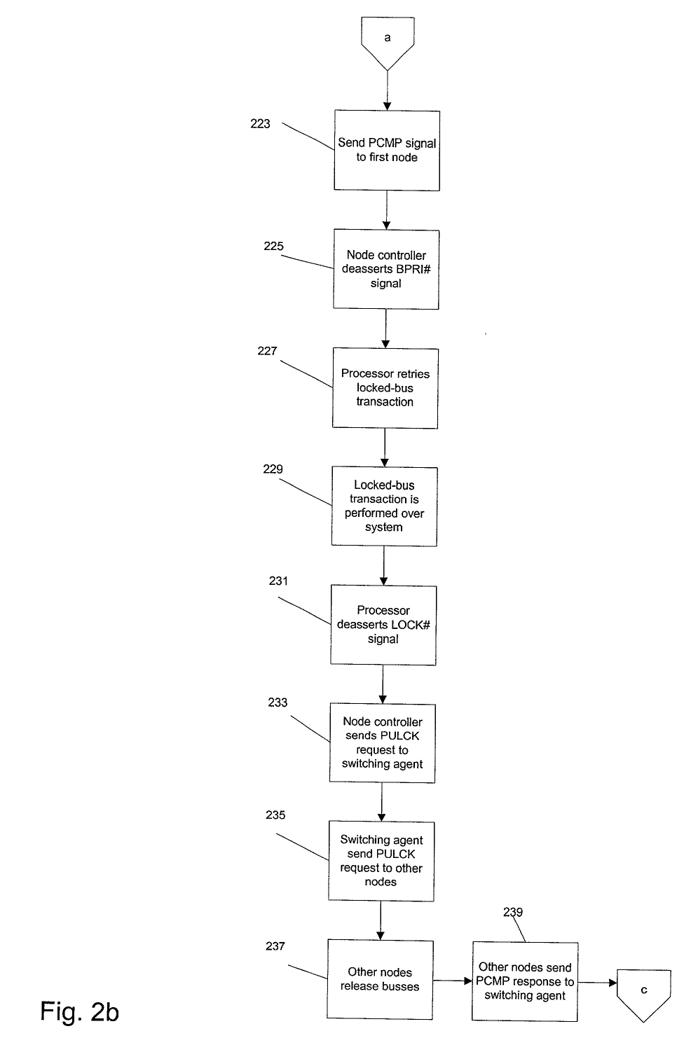

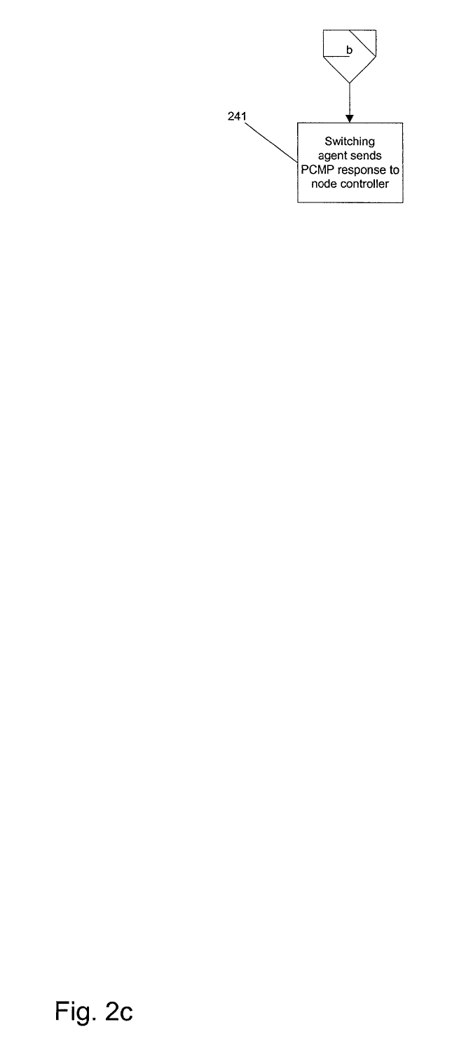

Referring to FIGS. 2a-c, a flow diagram of a method for implementing a bus lock according to an embodiment of the present invention is shown. In the first part of this method, the bus agent goes through a lock acquire phases. In block 201, a bus agent (e.g., processor 111) initiates a locked-bus transaction. There are numerous ways that a processor can initiate such a transaction. In this embodiment, at least part of the transaction includes the assertion of the LOCK# signal and the address of the memory location to be read in the first part of the locked-bus transaction. In block 203, the node controller 115 does not accept this locked-bus transaction (e.g., by asserting an appropriate signal, DEFER# in this embodiment, and by giving a retry response), causing the processor to retry the locked-bus transaction until it is accepted. In block 205, the node controller 115 blocks the system bus 113 from generating any new requests (e.g., by asserting an appropriate signal onto the system bus 113, BPRI# in this embodiment). In block 207, the node controller 115 initiates a lock request to the switching agent 140 after completion of all other outstanding transactions from the first node 110, except a purge translation cache request (PPTC request in this embodiment). In this embodiment, the lock request is referred to as PLCK request and is asserted on the external connection 118 along with the address of the first read in the locked-bus transaction. In decision block 209, switching agent 140 determines whether any other node (e.g., second node 120 and third node 130) is seeking to perform a locked-bus transaction. In this embodiment, a separate area of dedicated memory (e.g., a snoop pending table (SPT)) available to the switching agent 140 keeps track of what, if any, locked-bus transaction is pending. If one is pending, control passes to block 21 0 where the switching agent transfers an appropriate response (e.g., a retry response) to cause the requesting node controller 115 to retry the lock request signal at a later time (e.g., at block 201). If desired, the node controller 115 may deassert the BPRI# signal as it knows that no other locked-bus transactions are being sought by other nodes in the system. Again, dedicated memory may be provided to indicate when a node has a pending PLCK transaction request from other nodes.

If there are no locked-bus transactions pending in decision block 209, control passes to block 211 for the switching agent 140 to set the appropriate value in the SPT to indicate that a locked-bus transaction is taking place. In block 213, the switching agent 140 sends a PLCK request to other processor nodes coupled to it (e.g., second processor node 120 and third processor node 130). In block 215, each of the corresponding node controllers (node controllers 125 and 135 in this example) receives the PLCK request from the switching agent 140 and seeks to stop accepting any further node requests. In this embodiment, this is achieved by asserting the BPRI# signal at nodes 120 and 130. Once all current, outstanding transactions from the node are completed, except a purge translation cache request (PPTC request in this embodiment), node controllers 120 and 130 each send an appropriate response to indicate that the locked-bus transaction can proceed (block 217). In this embodiment, this is achieved through assertion of a PCMP (Complete) response to the switching agent 140.

Once the processor nodes 110, 120, and 130 are ready for the locked-bus transaction, the switching agent then insures that all I/O nodes (e.g. node 150) are ready for the transaction. In block 219, a flush request is sent to each I/O node. In this embodiment, the request signal is referred to as a PFLUSH request. In response to the PFLUSH request, the I/O node 150 blocks all of its I/O agents (I/O devices 152) by retrying any new requests from them. Once all current, outstanding transactions are completed from I/O node 150, it sends a PCMP response to the switching agent 140 (block 221). At this point the multi-node system 100 is ready for the locked-bus transaction and a PCMP signal is sent from the switching agent 140 to the first processor node 110 (block 223; FIG. 2b).

In one embodiment of the above flow, if the PLCK request is targeted to an I/O node, then after receiving a PCMP response for each PFLUSH the switching agent 140 sends a PLCK request to the target I/O node. On receiving a PLCK request, the I/O node removes the block on the target I/O connection and issues a locked read request with the address provided by the PLCK request. Once the lock read request completes on the I/O connection, the data response is sent back to the switching agent 140. The response is sent using PCMP_D in this embodiment. The switching agent 140 sends the PCMP_D response to the first processor node 110.

At this point the lock acquire phase is complete. In block 225, the node controller 115 deasserts the BPRI# signal to allow the processor 111 to initiate the locked bus transaction (block 227). As before, in this embodiment, the processor initiates the locked-bus transaction by asserting the LOCK# signal. To insure that the locked-bus transaction by processor 111 is next, other bus transactions would have to be denied until the transaction by processor 111 is completed. In block 229, the locked-bus transaction is allowed to proceed by the processor 111 over system 100. In one embodiment, when the transaction is directed to an I/O device (e.g., at I/O node 15), the data may have been prefetched during the lock acquire phase. In this case, the data is simply returned to the processor for the next part of the locked-bus transaction. In another embodiment, if the accesses during a lock sequence from a processor is directed to a memory location that can be copied into caches, then the coherent read transactions carry a special attribute to indicate to the memory manager in the switching agent 140 not to allocate the cache line in the snoop filter if it is not already present. In this embodiment, this attribute is called LCK. This is done to avoid generation of any new transaction during the lock sequence from the memory manager at the switching agent due to replacement of a cache line from the snoop filter. Also, in this embodiment, the writes in the lock sequence to memory locations that can be present in the caches is done using a read invalidate transaction with the special LCK attribute, followed by merging of write to the result of the read invalidate transaction, followed by writing the modified cache line to the memory. In this embodiment, the memory update is done using a non-coherent memory write, which does not interact with the snoop filter in the switching agent.

In block 231, and after the series of transactions in the lock sequence is completed, processor deasserts the LOCK# signal. In block 233, the node controller 115, in response to the deasserted LOCK# signal sends a PULCK (Unlock) signal over external connection 118 to switching agent 140. In this embodiment, the node controller 115 does not deassert the BPRI# signal until a response is received from the switching agent 140 that the system is effectively unlocked. In block 235, the switching agent 140 sends a PULCK signal first to the target of the previous PLCK request. On receiving the PULCK request, the target node releases the block on initiating new requests and responds with a PCMP response. Once a PCMP response is received by the switching agent 140 from the target node, then a PULCK request is sent to all other processor nodes (e.g., nodes 120 and 130) and all other I/O nodes (e.g., node 150). In block 237, the other nodes release or unlock their nodes so that new transactions may be initiated. This may be done, for example, in nodes 120 and 130 by deasserting the BPRI# signal. In block 239, the other nodes confirm that the busses have been released by sending a PCMP signal to the switching agent 140. In block 241, the switching agent 140 sends a confirmation signal (PCMP) to the first node 110 to confirm that all other nodes have been “unlocked” allowing another locked-bus transaction or any other transaction to occur. Finally, the node controller 115 deasserts the BPRI# signal at first node 110 to allow new transactions to be initiated at the first node 110.

In embodiments where multiple switching agents are present in the system, all the PLCK and PULCK requests from any node initiating a lock sequence is sent to the same switching agent in the system. Once the lock acquire phase is complete with the completion of a PLCK request, then the node initiating the lock sequence sends a flush request (PFLUSH request in this embodiment) to other switching agents in the system. On receiving a PFLUSH request, the switching agent completes all outstanding transactions and returns a completion response. After receiving completion responses for PFLUSH from all other switching agents, the node initiating the lock sequence proceeds with the series of accesses in the lock sequence.

Using the above system, a multi-node system is able to have locked-bus transactions without concerns that an agent, such as a processor or an I/O device will be able to access the address locations of the transaction while the transaction is taking place.

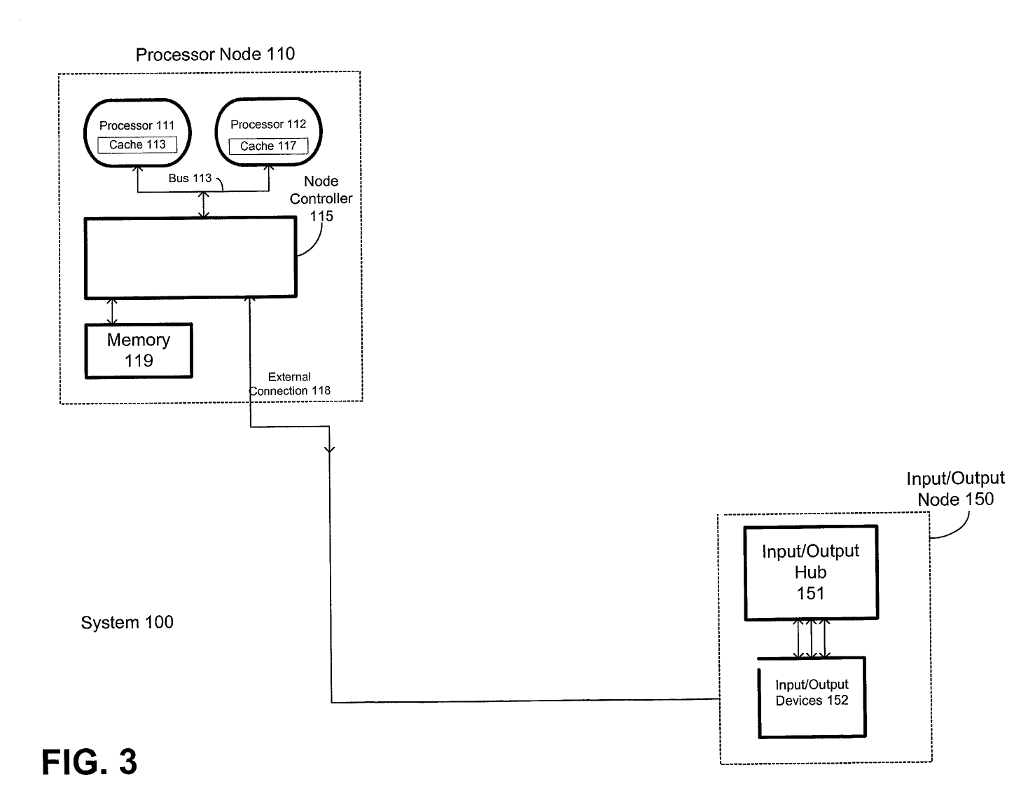

Referring to FIG. 3, a block diagram of a system that does not include a switching agent and includes one processor node and one I/O node is shown. Like reference numbers are used for comparable components in FIG. 3. In this figure, the processor node 110, which includes a node controller 115, is coupled directly to an I/O node 150 via an external connection 118. In this example, if a bus agent (e.g, processor 111) seeks to initiate a locked-bus transaction locally (i.e., at node 110), it will proceed normally through the assertion of the LOCK# signal. If, on the other hand, the locked-bus transaction is to occur between the first node 110 and the I/O node 150, then a PLCK request is sent by the node controller 115 to the I/O hub 151. In response to the PLCK request, the I/O node 150 blocks all of its I/O agents (I/O devices 152) by not accepting any new requests from them. Once all current, outstanding transactions are completed from I/O node 150, it sends a PCMP response to the node controller 115. At this point, the system shown in FIG. 3 is ready for the series of transactions in the lock sequence to proceed. When the transactions in the lock sequence are complete and the processor deasserts the LOCK# signal, the node controller 115 sends a PULCK signal to the I/O node 150. When the I/O hub 151 has released or unlocked its node and I/O devices so that new transactions may be initiated, it sends a PCMP signal to the node controller indicating such. As with the system shown in FIG. 1, the node controller may assert and deassert the BPRI# to control the initiation of new transactions from the processors coupled within the node.

Although several embodiments are specifically illustrated and described herein, it will be appreciated that modifications and variations of the present invention are covered by the above teachings and within the purview of the appended claims without departing from the spirit and intended scope of the invention. What is claimed is:

1. A method for executing a locked bus transaction in a multi-node system, comprising:
initiating a locked-bus transaction at a bus agent;
transmitting a locked-bus request to a first node controller; and
deferring the locked-bus transaction at the bus agent by said first node controller.

2. The method of claim 1 further comprising:
transmitting the locked-bus request from the first node controller to a second node controller.

3. The method of claim 2 further comprising:
preventing bus transactions on a bus coupled to said second node controller.

4. The method of claim 3 further comprising:
performing the locked-bus transaction by the bus agent over the multi-node system.

5. The method of claim 1 further comprising:
asserting a signal to said bus agent by said first node controller to prevent said bus agent from initiating a bus transaction.

6. The method of claim 5 further comprising:
transmitting the locked-bus request from the first node controller to a second node controller.

7. The method of claim 6 further comprising:
preventing bus transactions on a bus coupled to said second node controller.

8. The method of claim 7 further comprising:
deasserting said signal to said bus agent by said first node controller.

9. The method of claim 8 further comprising:
performing the locked-bus transaction by the bus agent over the multi-node system.

10. A multi-node system comprising:
a bus agent to initiate a locked-bus transaction; and
a first node including a first bus and a first node controller to receive a locked-bus request and defer the locked-bus transaction at the bus agent.

11. The system of claim 10 further comprising:
a second node including a second bus and a second node controller to receive the locked-bus request from the first node controller.

12. The system of claim 11 wherein said second node controller is to prevent bus transactions on said second bus.

13. The system of claim 12 wherein the bus agent is to perform the locked-bus transaction over the multi-node system.

14. The system of claim 10 wherein said first node controller is to assert a signal to said bus agent to prevent said bus agent from initiating a bus transaction.

15. The system of claim 14 further comprising:
a second node including a second bus and a second node controller to receive the locked-bus request from the first node controller.

16. The system of claim 15 wherein said second node controller is to prevent bus transactions on said second bus.

17. The system of claim 16 wherein said first node controller is to deassert said signal to the bus agent.

18. The system of claim 17 wherein the bus agent is to perform the locked-bus transaction over the multi-node system.

19. A method for executing a locked bus transaction in a multi-node system, comprising:
initiating a locked-bus transaction at a bus agent;
transmitting a locked-bus request to a first node controller;
deferring the locked-bus transaction at the bus agent by said first node controller;
transmitting the locked-bus request from the first node controller to a switching agent; and
preventing further transactions from said switching agent.

20. The method of claim 19 further comprising: performing the locked-bus transaction by the bus agent over the multi-node system via the switching agent.

21. A method for executing a locked bus transaction in a multi-node system, comprising:
initiating a locked-bus transaction at a bus agent for a first I/O node including a first I/O device;
transmitting a locked-bus request to a first node controller; and
deferring the locked-bus transaction at the bus agent by said first node controller.

22. The method of claim 21, further comprising: transmitting the locked-bus request from the first node controller to the first I/O node.

23. The method of claim 22, further comprising: preventing transactions at the first I/O node for I/O devices coupled in said first I/O node.

24. The method of claim 23,further comprising:
performing the locked-bus transaction by the bus agent over the multi-node system to the first I/O device.
